(19) United States
(12) Patent Application Publication
(10) Pub. No.: US 2008/0129499 A1
(43) Pub. Date: Jun. 5, 2008

(54) Glass Panel and Glass Panel Breakage Detection System

(75) Inventor: Yoshimi Masuzaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Nippon Sheet Glass Company, Limited, Tokyo (JP)

(21) Appl. No.: 11/794,340

(22) PCT Filed: Oct. 28, 2005
(86) PCT No.: PCT/JP05/19930

§ 371 Date: Jun. 28, 2007

(30) Foreign Application Priority Data
Dec. 28, 2004 (JP) 2004-381907

(51) Int. Cl. B32B 17/00; G08B 13/04; E06B 7/28; C03C 27/06; G08B 13/22

(52) U.S. Cl. 340/545.1; 428/410

(57) ABSTRACT

Breakage of a glass panel is detected by a simple structure practically without disfiguring the glass panel. A glass panel breakage detection system (12) has a glass panel (10), a reading device (14), and a notification device (16). The glass panel (10) has plate glass (18) formed of reinforced glass, an antenna (22) provided on the surface of the plate glass (18), and an ID chip (24) connectedly attached to the antenna (22) and transmitting, by radio communications through the antenna (22), identification information as a reply to a request from the outside. The reading device (14) acquires the identification information from the ID chip (24) by radio communications through the antenna (22). When a trouble occurs in the acquisition of the identification information by the reading device (14), the notification device (16) notifies the fact to the request from the reading device (14) to the radio chip.

### TECHNICAL FIELD

The present invention relates to a glass panel and a glass panel damage detection system.

### BACKGROUND ART

Window panes of buildings such as houses, offices and stores are often equipped with alarm devices for prevention of crimes. Alarm devices of this type respond to a situation where a window is forced open or a window pane is broken, by sounding an alarm or by indicating the incidence by an alarm light. With this, tenants, neighbors or the security company can know that the window is forced open or the window pane is damaged.

In one known example of a system for detecting damage to a window pane, a network of electric circuits is provided on the glass surface of the window pane (see, for example, patent document No. 1). In this system, damage to the window pane is detected by disconnection of the electric circuit, and an alarm device is activated accordingly.

[Patent document No. 1]

### JP 2002-163732

### DISCLOSURE OF THE INVENTION

### Problem to be Solved by the Invention

In the above-described window pane damage detection system, it is necessary to wire the electric circuit provided on the surface of the glass to a detecting device, for detecting disconnection of the electric circuit, provided in the neighborhood of the window pane. Consequently, the structure to be provided in the window and in the neighborhood thereof will be complex. Wiring or the detecting device may represent an obstacle when the window is opened or closed, or when people come and go through the window pane.

Due to the wiring between the electric circuit and the detecting device in this window pane damage detection system, the electric circuit should be provided in substantially the entirety of the surface of the glass, with the result that the appearance of the window pane and the neighborhood thereof may be impaired.

In this background, a general purpose of the present invention is to detect damage to a glass panel with a simple structure and without materially impairing the appearance.

A glass panel according to first embodiment of the present invention comprises: a glass sheet formed of tempered glass; an antenna provided on the surface of the glass sheet; and a wireless chip connected to the antenna and operative to wirelessly transmit, via the antenna, identification information in response to a request from an external source.

A glass panel according to second embodiment comprises: a first glass sheet and a second glass sheet, at least one of the first glass sheet and the second glass sheet being formed of tempered glass; an anchoring frame operative to fix the first glass sheet and the second glass sheet so as to be parallel and opposite to each other so that an air gap layer is formed between the first glass sheet and the second glass sheet; an antenna provided on at least one of the first glass sheet and the second glass sheet which is formed of tempered glass; a wireless chip connected to the antenna and operative to wirelessly transmit, via the antenna, identification information in response to a request from an external source.

Accordingly, damage to a glass panel is detected with a simple structure and without materially impairing the appearance.

The antenna of the glass panel according to said the second embodiment may be provided on the surface of at least one of the first glass sheet and the second glass sheet which is formed of tempered glass so as to face the air gap layer.

Accordingly, corrosion, drop or robbery of an antenna is prevented because the antenna is not exposed outside.

The wireless chip of the glass panel according to the first embodiment or the second embodiment may be driven by electromotive force provided by an electromagnetic wave received from an external source. Since a wireless chip of passive type does not have a built-in power supply and is smaller than the chip of active type, the appearance of the glass panel is maintained more successfully, and maintenance of the glass panel in relation to a power supply is not necessary.

An embodiment of glass panel damage detection system of the present invention comprises: the aforementioned glass panel; a reader operative to wirelessly obtain, via the antenna, identification information from the wireless chip; and an alarm device operative, when the reader fails to obtain the identification information properly in response to a request from the reader to the wireless chip, to alert of the failure.

Accordingly, damage to a glass panel is detected with a simple structure and without materially impairing the appearance.

Appropriate combinations of the aforementioned elements are also within the scope of the invention sought to be protected by this application.

### ADVANTAGE OF THE INVENTION

According to the embodiments, damage to a glass panel is detected with a simple structure and without materially impairing the appearance.

### BRIEF DESCRIPTION OF THE DRAWINGS

FIG. 1 is a schematic view showing the cross section of a glass panel damage detection system 12 according to embodiments of the present invention.

FIG. 2 shows the appearance of an RFID tag according to an embodiment of the present invention.

FIG. 3 shows the blocks of an ID chip of the RFID tag of FIG. 2.

FIG. 4 shows the blocks of a reader according to embodiments of the present invention.

FIG. 5 is a flowchart showing how damage to a glass sheet is detected by the glass panel damage detection system of FIG. 1.

FIG. 6 is a schematic view showing the cross section of a glass panel according to the second embodiment of the present invention.

### DESCRIPTION OF THE REFERENCE NUMERALS

10, 70 glass panel, 12 glass panel damage detection system, 14 reader, 16 alarm device, 18 glass sheet, 20 RFID tag, 22 antenna, 24 ID chip, 62 first glass sheet, 64 second glass sheet, 72 air gap layer, 74 anchoring frame

### BEST MODE FOR CARRYING OUT THE INVENTION

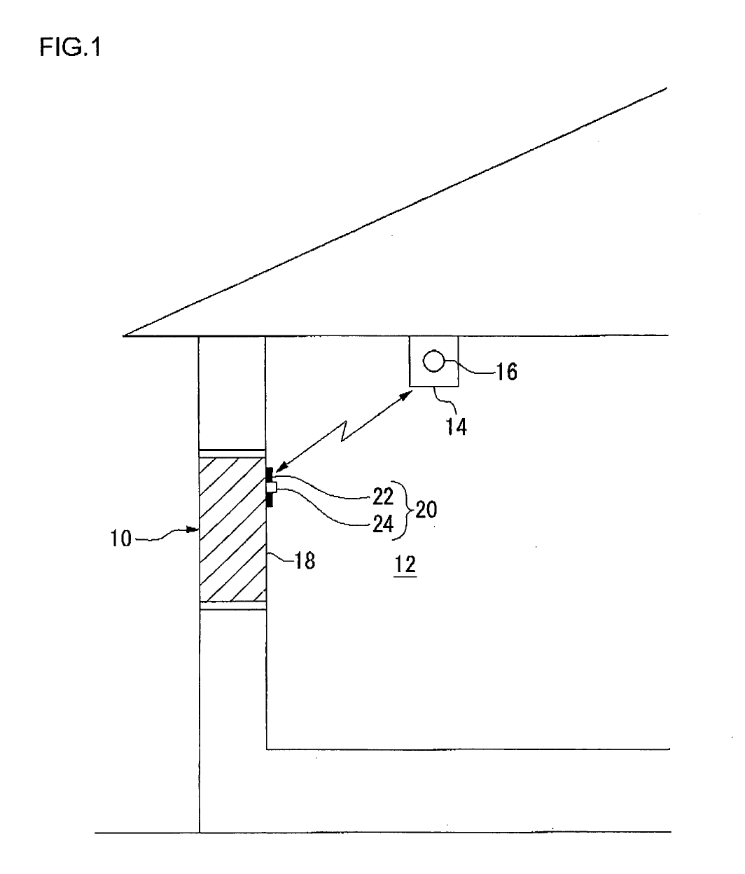

A description will now be given, with reference to FIGS. 1 through 5, of a glass panel damage detection system 12 according to the first embodiment of the present invention which includes a glass panel 10. The use of the glass panel 10 according to the first embodiment as a window for a building will be described by way of example. The glass panel damage detection system 12 according to the embodiment is configured such that an antenna for an IC tag is adhesively attached to tempered glass so that damage to the glass is detected as a result of disconnection between the antenna and the chip occurring when the glass sheet is broken.

FIG. 1 shows the structure of the glass panel damage detection system 12 according to the embodiment of the present invention. As shown in FIG. 1, the glass panel damage detection system 12 is provided with a glass panel 10, a reader 14 and an alarm device 16. The glass panel 10 is provided with a glass sheet 18, an RFID (radio frequency identification) tag 20.

The glass sheet 18 is formed of tempered glass. High strength of tempered glass results from high compression stress at the surface.

Tempered glass is produced by, for example, heating glass to a temperature close to the softening point, blowing compressed air flow to the glass surface and then rapidly cooling the glass surface. By rapidly cooling the glass surface, a compression stress layer is formed on the surface of the glass and a tensile stress layer inside is formed inside. When a force exceeding the limit of compression stress on the surface is applied to a part of the tempered glass, a network of cracks develop at a high speed on the entirety of the surface of the tempered glass. The glass is broken into pieces without being dropped.

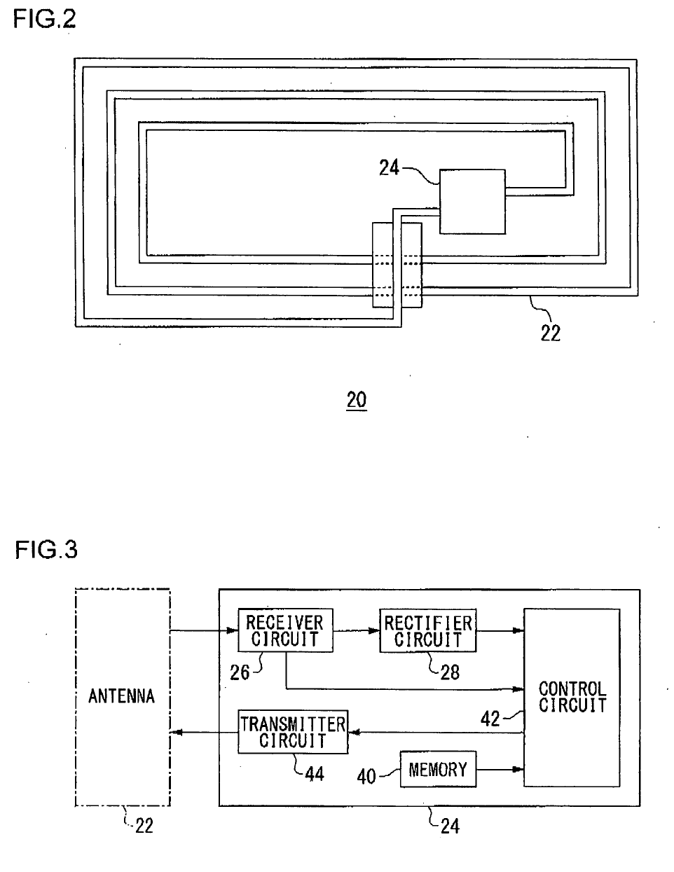

FIG. 2 shows the appearance of the RFID tag 20. The RFID tag 20 is provided with an antenna 22 and a ID chip 24 (wireless chip) for wirelessly transmitting, via the antenna 22, identification information in response to a request from an external source.

The antenna 22 is adhesively attached to the surface of the glass sheet 18 so as to face the inside. The antenna 22 in this embodiment is pasted onto the glass sheet 18. Alternatively, or in addition to this, the antenna 22 may be provided on the glass sheet 18 by plating, transfer printing, painting, coating or vapor deposition.

The antenna 22 in this embodiment is provided on the glass sheet 18 so as to face the inside. Alternatively, the antenna 22 may be provided on the surface of the glass sheet 18 so as to face the outside. It is preferable, however, to provide the antenna 22 on the surface of the glass sheet 18 so as to face the inside for suppression of corrosion, degradation, robbery or tampering.

The ID chip 24 is of so-called passive type driven by electromotive force provided by an electromagnetic wave received from an external source. For this reason, on-site (i.e., the glass panel 10 and the neighborhood thereof) maintenance of the ID chip 24 in relation to a power supply is not necessary.

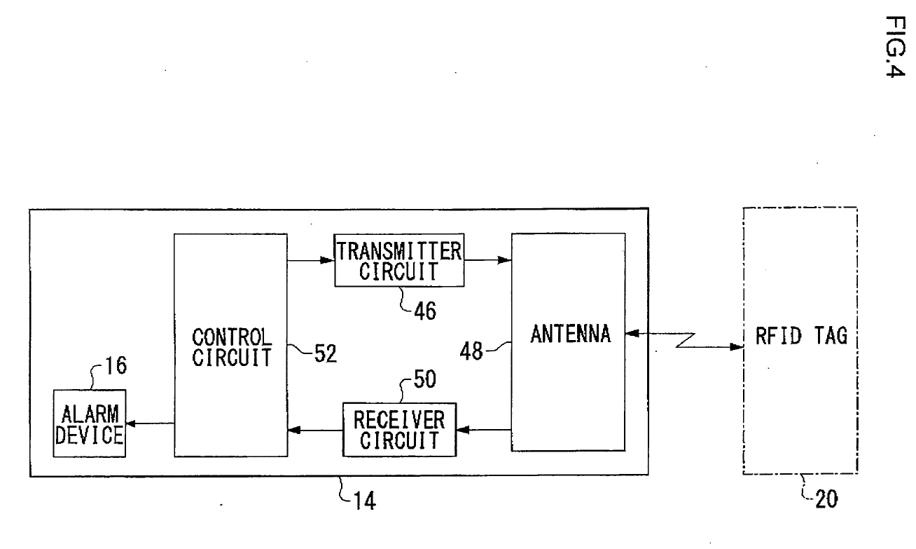

FIG. 3 shows the functional blocks of the ID chip 24. As shown in FIG. 3, the ID chip 24 is provided with a receiver circuit 26, a rectifier circuit 28, a memory 40, a control circuit 42 and a transmitter circuit 44. The receiver circuit 26 outputs an electromagnetic wave received by the antenna 22 to the rectifier circuit 28 and generates a clock signal from the electromagnetic wave received by the antenna 22 for output to the control circuit 42. The rectifier circuit 28 rectifies the electromagnetic wave received by the receiver 26, converts the rectified wave to electric power and outputs the power to the control circuit 42 to drive the circuit 42.

The memory 44 stores the identification information.

The identification information stored in the memory 40 includes, for example, information related to the fabrication, components, functions and distribution of the glass sheet 18 but is not limited to these. If the RFID tag 20 is only used to detect damage to the glass panel 10, the contents of information do not matter and only the identification may be provided.

Upon receipt of the clock signal from the receiver circuit 26, the control circuit 42 retrieves the identification information from the memory 40 and outputs an information signal associated with the identification information to the transmitter circuit 44 along with a signal for transmission. The transmitter circuit 44 modulates, with the information signal, the signal for transmission fed by the control circuit 42 and outputs the modulated signal to the antenna 22. The antenna 22 transmits the signal modulated by the transmitter circuit 44. The signal transmitted from the antenna 22 is received by the reader 14.

Since the RFID tag 20 is small, provision thereof on the surface of the glass sheet 18 hardly impairs the appearance. The RFID tag 20 may be provided at an easily viewable position (e.g. the center) of the surface of the glass sheet 18. By providing the RFID tag 20 at an easily viewable position on the surface of the glass sheet 18, whether the window is open or closed can be known depending on whether the RFID tag 20 is viewed.

FIG. 4 shows the functional blocks of the reader 14. The reader 14 obtains the identification information from the ID chip 24 by wireless communication via the antenna 20 of the RFID tag 20. The reader 14 comes with various sizes and shapes. For example, the reader 14 may be portable, having the size of a card.

As shown in FIG. 4, the reader 14 is provided with a transmitter circuit 46, an antenna 48, a receiver circuit 50, a control circuit 52 and an alarm device 16. The transmitter circuit 46 generates an electromagnetic wave, transmits the electromagnetic wave to the RFID 20 via the antenna 48, and transmits a signal including the identification information and transmitted from the RFID tag 20.

The receiver circuit 50 retrieves, from the received signal, the identification information stored in the ID chip 24 and outputs the information to the control circuit 52. When the receiver circuit 50 fails to obtain the identification information properly in response to a request from the receiver circuit 50 to the ID chip 24, the alarm device 16 alerts of the failure.

Failure to properly obtain the identification information encompasses cases different from normal obtaining of the identification information including: i) cases where the identification information cannot be obtained; ii) cases where there is a mixture of failure to obtain the identification information and successful obtaining of the identification information; iii) cases where only a part of the identification information is obtained; iv) cases where wrong identification information is obtained; v) cases where it takes time to obtain the identification information, or vi) cases where the identification information cannot be obtained unless by increasing the power of electromagnetic wave transmitted by the reader.

In this embodiment, the reader 14 is provided with an alarm device 16. Alternatively, the alarm device 16 may be provided outside the reader 14. In this case, the reader 14 is connected to the reader 16. The control circuit 52 sends a signal to the alarm device 16 so as to activate the alarm device 16. The control circuit 52 in the reader 14 and the alarm device 16 outside the reader 14 may communicate wirelessly so as to activate the alarm device 16.

The alarm device 16 may alert of failure to properly obtain identification information, by audio, character display, symbol display, still image, moving image or a combination thereof. Examples of the alarm device 16 include a siren, rotating warning light, electric light, electric bulletin board and warning flare. The alarm device 16 may be configured to communicate the failure to a remote location monitoring the glass panel 10. An alarm issued in the neighborhood of the glass panel 10 and communication to a location remote from the glass panel 10 may be combined to achieve favorable results.

In the glass panel damage detection system 12 according to the embodiment, electromagnetic waves at Various frequencies (e.g., 135 kHz, 13.56 MHz, 433 MHz, 869 MHz, 915 MHz or 2.45 GHz) may be used. These electromagnetic waves have respective characteristics. Therefore, the RFID 20 is preferably used in a condition adapted to the characteristics of the electromagnetic waves at respective frequencies. For example, an electromagnetic wave at 869 MHz allows long-distance communication and so the RFID tag 20 can be used even if it is at a distance from the reader 14. The RFID tag 20 using an electromagnetic wave at 2.45 GHz may be small so that it can be used at locations where the RFID tag 20 attached to the surface of the glass should remain unnoticed as much as possible (e.g., in a showcase of jewelry).

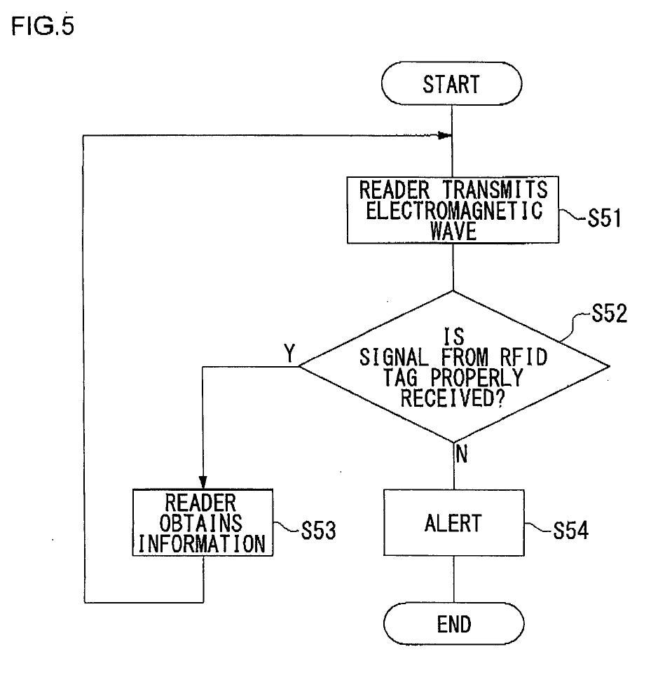

A description will be described, with reference to FIG. 5, of a procedure for detecting damage to the glass sheet 18 by the glass panel damage detection system 12.

FIG. 5 shows how damage to the glass sheet 18 is detected by the glass panel damage detection system 12. The reader 14 transmits an electromagnetic wave to the RFID tag 20 (S51). Subsequently, the RFID tag 20 receives the electromagnetic wave of S51 and responds to the wave by transmitting to the reader 14 a signal containing information stored in the ID chip 24 (S52). When the antenna 22 is not damaged, transmission can take place normally (Y in S52). When the antenna 22 is damaged, transmission cannot take place normally (N in S52).

Subsequently, the reader 14 receives the signal transmitted from the RFID tag 20 and obtains the identification information stored in the ID chip 24 (S53). However, failure occurs in obtaining the identification information stored in the ID chip 24 unless the ID chip 24 properly receives a signal.

Subsequently, the reader 14 transmits an electromagnetic wave again to the RFID tag 20 (S51). The interval for transmission of the electromagnetic wave is appropriately set. In the event that the reader 14 fails to obtain the identification information stored in the ID chip 24 properly, the alarm device 16 alerts of the failure (S54).

As mentioned before, tempered glass, once partially damaged, will have a network of cracks on the entirety of the surface thereof. This will cause at least a part of the antenna 22 to be damaged, preventing the ID chip 24 from properly providing the identification information wirelessly via the antenna 22. As a result, the reader 14 fails to obtain the identification information from the ID chip 24 properly. Accordingly, when the reader 14 fails to obtain the identification information properly in response to a request from the reader 14 to the ID chip 24, it is possible to determine that the tempered glass of the glass panel 10 is broken.

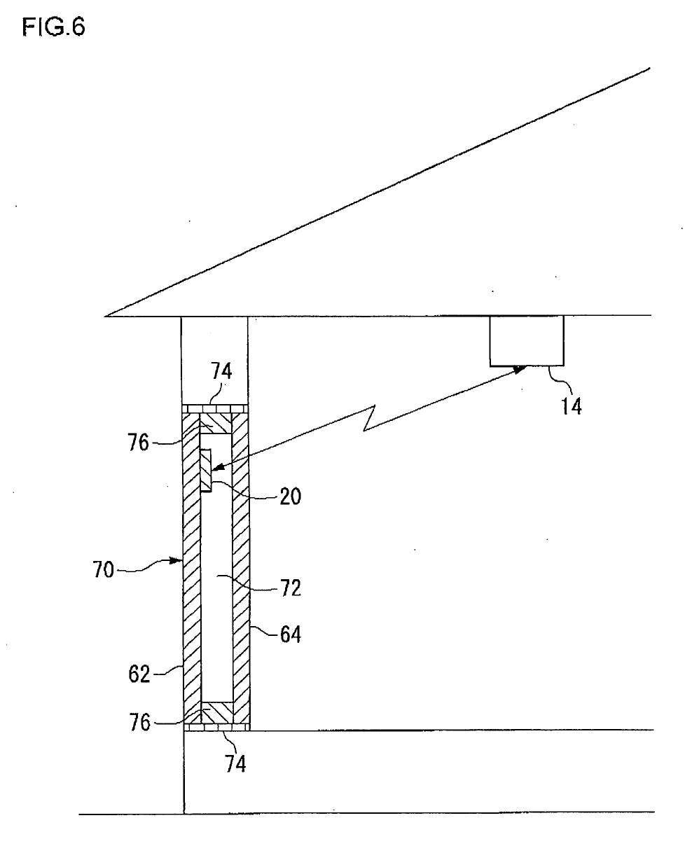

A description will now be given, by referring to FIG. 6, of a glass panel 70 according to the second embodiment. The description of those aspects of the second embodiment that are identical to the corresponding aspects of the first embodiment will be omitted. Those components identical with or corresponding to components of the glass panel 10 according to the first embodiment are designated by the same reference numerals. In describing the second embodiment, it will be assumed that the glass panel 70 is used as an insulating glass unit sash of a house.

FIG. 6 shows the cross section of the glass panel 70.

As shown in FIG. 6, the glass panel 70 comprises: a first glass sheet 62 facing the outside and formed of tempered glass; a second glass sheet 64 facing the inside; an anchoring frame 74 for securing the first glass sheet 62 and the second glass sheet 64 so as to be parallel and opposite to each other so that an air gap layer 72 is formed between the first glass sheet 62 and the second glass sheet 64; and an RFID tag 20 provided on the first glass sheet 62 so as to face the air gap layer 72. The RFID tag 20 is provided with an antenna 22 and an ID chip 24. The antenna 22 is provided on the surface of the first glass sheet 62 so as to face the air gap layer 72.

Argon gas, helium gas or high vacuum gas is sealed in the air gap layer 72 so that heat insulation between the first glass sheet 62 and the second glass sheet 64 is improved. The glass panel 70 is provided with a spacer 76 sandwiched between the first glass sheet 62 and the second glass sheet 64 and hermetically sealing the gas in the air gap layer 72.

The RFID tag 20 receives an electromagnetic wave at certain intervals (e.g., at intervals of one minute) from the reader 14 located inside the building. In response to a request from the reader 14, the RFID tag 20 sends a signal including the identification information stored in the ID chip 24. When a burglar attempts to steal something inside the building by breaking the insulating glass unit, the reader 14 fails to obtain identification information from the RFID tag 20 properly, enabling the detection of the destruction of the first glass sheet 62. By ensuring that an outdoor siren is activated and rotating warning light comes on in response to the detection of the destruction of the first glass sheet 62, the chances of preventing burglary or capturing a burglar will be improved.

In the second embodiment, the antenna 22 is provided on the surface of the first glass sheet 62 so as to face the air gap layer 72. Alternatively, the antenna 22 may be provided on the first glass sheet 62 so as to face the outside. The second glass sheet 64 may be formed of tempered glass. In this case, instead of providing the antenna 22 on the first glass sheet 62 or in addition to providing the antenna 22 on the first glass sheet 62, the antenna 22 may be provided on the second glass sheet 64 so as to face the air gap layer 72 or to face the outside.

For suppression of corrosion, degradation, robbery or tampering, it is preferable, however, to provide the antenna 22 on the surface of the first glass sheet 62 so as to face the air gap layer 72, or on the surface of the second glass sheet 64 so as to face the air gap layer 72 or to face the inside. When the antenna 22 is formed on the second glass sheet 64, the first glass sheet 62 may not be formed of tempered glass.

When the glass panel 70 according to the second embodiment is used as an insulating glass unit for viewing of a beast in an animal enclosure of a zoo, the second glass sheet 64 may be formed of tempered glass so that destruction of the second glass sheet 64 is detected by the RFID tag 20 and the reader 14 when the beast in the animal enclosure attempts to get outside by breaking the insulating glass unit. In this case, an operation to capture the beast can be initiated immediately by configuring the alarm device 16 to alert the control center of the zoo of the destruction of the second glass sheet 64.

If the beast is a rare animal, a burglar may break the insulating glass unit to break into the animal enclosure and steal the animal. Thus, in this case, the first glass sheet 62 may also be formed of tempered glass, and the RFID tag 20 may be formed on the surface of the first glass sheet 62 so as to face the air gap layer 72 or to face the outside. By providing the RFID tag 20 in the first glass sheet 62 and the second glass sheet 64, robbery and escape of a rare beast are prevented.

Described above is an explanation of the invention based on the embodiments. The present invention is not limited in scope to the embodiments described, and various variations to the design etc. would be made on the basis of the knowledge of a skilled person. Such variations are also within the scope of the present invention.

In the second embodiment, the first glass sheet 62 and the second glass sheet 64 are arranged substantially parallel with each other. Alternatively, the interval between the first glass sheet 62 and the second glass sheet 64 may be such that the interval is relatively small toward the top or bottom thereof. Still alternatively, one of the first glass sheet 62 and the second glass sheet 64 may be smaller in width than the other.

The RFID tag 20 of the glass panel 10 and the glass panel 70 of the embodiments is of passive type. Alternatively, the RFID tag may be of active type such that a solar cell is attached on the surface of the glass sheet and the ID chip 24 is connected to the solar cell.

The glass panel 10 and the glass panel 70 according to the embodiments may be used to constitute an insulating glass unit (e.g., a three-layer glass).

### INDUSTRIAL APPLICABILITY

According to the present invention, damage to a glass panel is detected with a simple structure and without materially impairing the appearance.

1. A glass panel comprising:
a glass sheet formed of tempered glass;
an antenna provided on the surface of the glass sheet; and
a wireless chip connected to the antenna and operative to wirelessly transmit, via the antenna, identification information in response to a request from an external source.

2. A glass panel comprising:
a first glass sheet and a second glass sheet, at least one of the first glass sheet and the second glass sheet being formed of tempered glass;
an anchoring frame operative to fix the first glass sheet and the second glass sheet so as to be parallel and opposite to each other so that an air gap layer is formed between the first glass sheet and the second glass sheet;
an antenna provided on at least one of the first glass sheet and the second glass sheet which is formed of tempered glass;
a wireless chip connected to the antenna and operative to wirelessly transmit, via the antenna, identification information in response to a request from an external source.

3. The glass panel according to claim 2, wherein
the antenna is provided on the surface of at least one of the first glass sheet and the second glass sheet which is formed of tempered glass so as to face the air gap layer.

4. The glass panel according to claim 1, wherein the wireless chip is driven by electromotive force provided by an electromagnetic wave received from an external source.

5. A glass panel damage detection system comprising:
a glass panel according to claim 1;
a reader operative to wirelessly obtain, via the antenna, identification information from the wireless chip; and
an alarm device operative, when the reader fails to obtain the identification information properly in response to a request from the reader to the wireless chip, to alert of the failure.

6. The glass panel according to claim 2, wherein the wireless chip is driven by electromotive force provided by an electromagnetic wave received from an external source.

7. The glass panel according to claim 3, wherein the wireless chip is driven by electromotive force provided by an electromagnetic wave received from an external source.

8. A glass panel damage detection system comprising:
a glass panel according to claim 2;
a reader operative to wirelessly obtain, via the antenna, identification information from the wireless chip; and
an alarm device operative, when the reader fails to obtain the identification information properly in response to a request from the reader to the wireless chip, to alert of the failure.

9. A glass panel damage detection system comprising:
a glass panel according to claim 3;
a reader operative to wirelessly obtain, via the antenna, identification information from the wireless chip; and
an alarm device operative, when the reader fails to obtain the identification information properly in response to a request from the reader to the wireless chip, to alert of the failure.

10. A glass panel damage detection system comprising:
a glass panel according to claim 4;
a reader operative to wirelessly obtain, via the antenna, identification information from the wireless chip; and
an alarm device operative, when the reader fails to obtain the identification information properly in response to a request from the reader to the wireless chip, to alert of the failure.

11. A glass panel damage detection system comprising:
a glass panel according to claim 6;
a reader operative to wirelessly obtain, via the antenna, identification information from the wireless chip; and
an alarm device operative, when the reader fails to obtain the identification information properly in response to a request from the reader to the wireless chip, to alert of the failure.

12. A glass panel damage detection system comprising:
a glass panel according to claim 7;
a reader operative to wirelessly obtain, via the antenna, identification information from the wireless chip; and
an alarm device operative, when the reader fails to obtain the identification information properly in response to a request from the reader to the wireless chip, to alert of the failure.
